(19) United States
(12) Patent Application Publication
(10) Pub. No.: US 2024/0149180 A1
(43) Pub. Date: May 9, 2024

(54) CREAMY SUBSTANCE

(71) Applicant: EPOCH COMPANY, LTD., Tokyo (JP)

(72) Inventor: Ryo SAKAI, Tokyo (JP)

(73) Assignee: EPOCH COMPANY, LTD., Tokyo (JP)

(21) Appl. No.: 18/386,046

(22) Filed: Nov. 1, 2023

(30) Foreign Application Priority Data
Nov. 4, 2022 (JP) 2022-177266

(51) Int. Cl. A63H 9/00; C08K 3/013

(52) U.S. Cl. CPC A63H 9/00; C08K 3/013

(57) ABSTRACT

A creamy substance for preparing a decoration toy including a resin, and a coloring agent including a pearl powder, in which the creamy substance is discharged from a piping tool, for the purpose of providing a creamy substance having glossiness and excellent in decorativeness, a piping tool for preparing the decoration toy, and the decoration toy.

### CROSS-REFERENCE TO RELATED APPLICATIONS

This application is based on and claims priority under 35 USC 119 from Japanese Patent Application No. 2022-177266 filed on Nov. 4, 2022, the contents of which are incorporated herein by reference.

### TECHNICAL FIELD

The present invention relates to a creamy substance.

### BACKGROUND ART

In the related art, toys that use tubes filled with a creamy resin to prepare simulated foods such as cakes have been proposed. For example, Patent Literature 1 discloses a toy set including a resin tube in which a tube container is filled with a cream resin, which is a synthetic resin. This toy set allows for easily forming a highly decorative decoration toy of simulated food as an accessory that simulates a nice looking food.

### CITATION LIST

### Patent Literature

Patent Literature 1: JP2010-152A

### SUMMARY OF INVENTION

### Technical Problem

The above creamy resin, which is a creamy substance, is available in various colors, and can be used to mold a decoration toy having colorful decorativeness. Glossiness is sometimes required for this type of creamy substance in order to form a more glittering decoration toy.

An object of the present invention is to provide a creamy substance having glossiness and excellent in decorativeness.

A creamy substance according to one embodiment of the present invention is a creamy substance that is a creamy resin to be discharged from a piping tool for preparing a decoration toy, and contains only a pearl powder as a coloring agent.

### Advantageous Effects of Invention

The above embodiment allows for providing a creamy substance having glossiness and excellent in decorativeness.

### BRIEF DESCRIPTION OF DRAWINGS

FIG. 1 is a front view of a piping tool for discharging a creamy substance according to an embodiment of the present invention.

FIG. 2 is a perspective view showing a state where the creamy substance according to the embodiment of the present invention is discharged onto a pedestal for a decoration toy.

FIG. 3 is a table for composition of two creamy substances prepared in Examples.

FIG. 4 shows a photograph of the creamy substance discharged from the piping tool.

### DESCRIPTION OF EMBODIMENTS

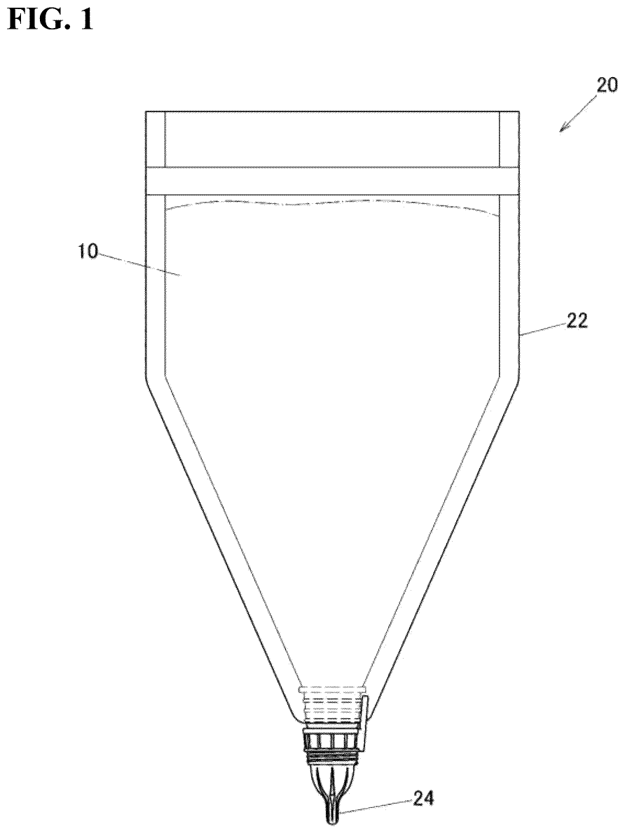

An embodiment of the present disclosure will be described with reference to the drawings. A creamy substance 10 according to an embodiment of the present disclosure is contained in a piping tool 20 as shown in FIG. 1, for example. A container 22 in the piping tool 20 is formed by stacking two flexible sheet members made of a polyvinyl chloride resin or the like and joining sides of the sheet members by thermocompression. A rear portion of the container 22 is closed like a bag by joining the two sheet members by thermocompression. A decoration toy can be prepared by discharging the creamy substance 10 through a discharge port 24 at a tip of the piping tool 20 and putting the creamy substance 10 on a surface for preparation of a decoration that simulates a cake or the like.

The creamy substance 10 referred to in this description is formed by adding a preservative or the like to a synthetic resin such as an acrylic resin, and is solidified when exposed to air and dried. The creamy substance 10 according to the present embodiment is formed by containing only 5.5 wt % of a pearl powder as a coloring agent, and is a resin having glossiness. When the creamy substance 10 contains the pearl powder in an amount of the above value, the glossiness can be effectively imparted to the creamy substance 10. Here, the expression “having glossiness” can apply to not only opaque products but also translucent products, and means that light is diffusely reflected on the surface and this allows products to look glittering.

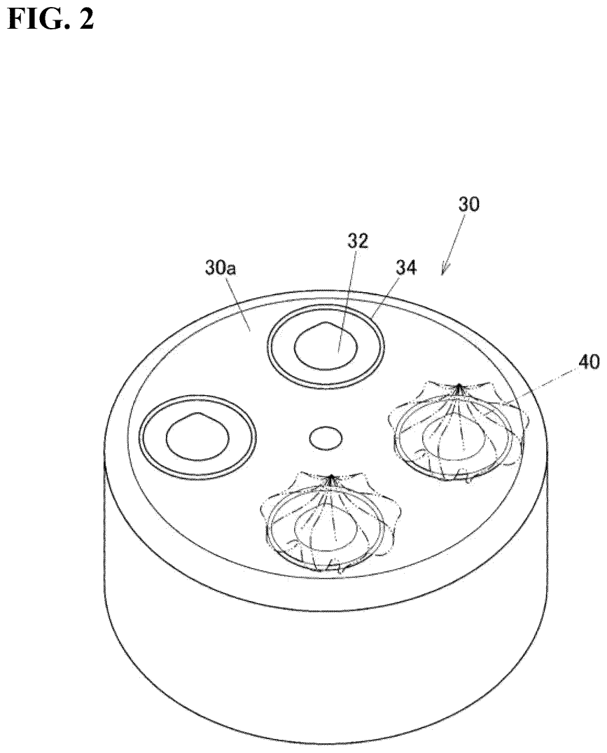

Next, an example in which the creamy substance 10 is discharged and put on a pedestal 30 of a decoration toy as shown in FIG. 2 will be described. The pedestal 30 has a circular shape in a top view, and is formed, for example, by injection molding with a resin material. An upper surface 30a of the pedestal 30 is a surface for preparation on which a decoration 40 is prepared. A decoration toy that simulates a circular cake can be prepared by putting the creamy substance 10 discharged from the piping tool 20 shown in FIG. 1 onto a decoration support portion 32 on the surface for preparation to form the decoration 40.

Four decoration support portions 32 are provided on the upper surface 30a of the pedestal 30 at a regular interval in a shape protruding in a substantially right circular conical shape. An annular convex portion 34 is provided on an upper surface of an outer periphery of the decoration support portion 32. The annular convex portion 34 is formed in a circular shape in a top view.

When the creamy substance 10 is put on the decoration support portion 32 of the pedestal 30, the creamy substance 10 is supported by the decoration support portion 32 with a good appearance. The annular convex portion 34 can be used as a guide for an area of the creamy substance 10 to be put, and can also prevent a protrusion of the creamy substance 10 to make the outer shape of the creamy substance 10 decorative. The creamy substances 10 put on all the decoration support portions 32 are dried and solidified to form the decorations 40, and the decoration toy is completed.

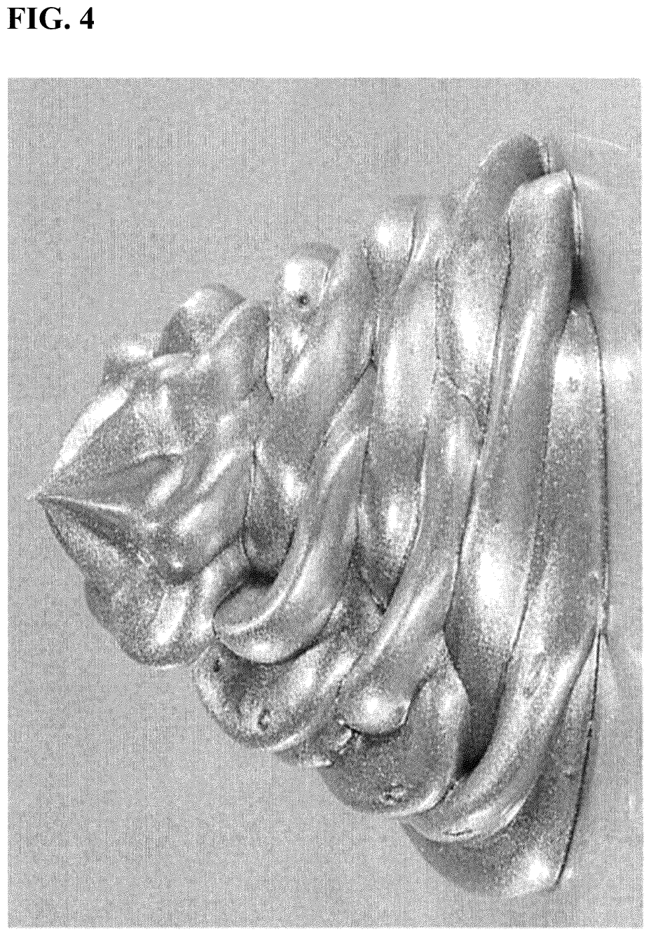

Here, as shown in FIG. 4, the creamy substance 10 according to the present embodiment has glossiness, and thus, the decoration 40 formed by drying and solidifying the creamy substance 10 put on each decoration support portion 32 also has glossiness, so that a glittering decoration toy can be completed.

As described above, the creamy substance 10 according to the embodiment contains only a pearl powder as a coloring agent, and thus, the creamy substance 10 has glossiness and is excellent in decorativeness. Therefore, as compared with a decoration toy formed of a creamy substance having no glossiness, a more colorful and glittering decoration toy can be easily molded, and a user can play with the decoration toy without getting tired of it.

The embodiment of the present disclosure described above allows for providing a creamy substance according to the following embodiments.

A creamy substance according to a first embodiment is a creamy substance that is a creamy resin to be discharged from a piping tool for preparing a decoration toy, and contains only a pearl powder as a coloring agent.

This configuration achieves a creamy substance having glossiness and excellent in decorativeness, and the use of this creamy substance allows for easily molding a colorful and glittering decoration toy.

The creamy substance according to a second embodiment contains the pearl powder in a range of 5 wt % to 6 wt %.

When the content of the pearl powder is less than the above range, the glossiness of the creamy substance is reduced, and when the content of the pearl powder is more than the above range, the glossiness increases but the color is darker. Particularly in the case of a white pearl powder, when the content of the pearl powder deviates from the above range, color fading occurs. According to the above configuration, when the creamy substance contains the pearl powder in the above range, the glossiness can be effectively imparted to the creamy substance.

The embodiment described above is presented as an example and is not intended to limit the scope of the invention. These novel embodiments can be implemented in various other forms, and various omissions, replacements, and modifications can be made without departing from the spirit of the invention. These embodiments and modifications thereof are included in the scope and gist of the invention, and are included in the scope of the invention described in the claims and equivalents thereof.

### Examples

In Examples, two types of creamy substances having glossiness were prepared. In Example 1, a white creamy substance having glossiness was prepared. In Example 2, a pink creamy substance having glossiness was prepared.

As a synthetic resin, a polyacrylic emulsion prepared based on 29 wt % of ethyl acrylate, 16 wt % of butyl acrylate, and 55 wt % of water was used. As a coloring agent, in Example 1, only a white pearl powder was blended, and in Example 2, only a white pearl powder and a pink pearl powder were blended. In addition, a small amount of phenoxyethanol was added as a preservative, and a small amount of mineral oil was added as a softener to maintain softness of the creamy substance after solidification.

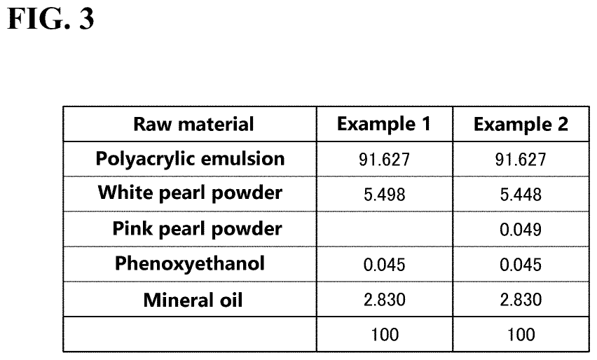

For Examples 1 and 2, a blending ratio of the polyacrylic emulsion, the pearl powder, the phenoxyethanol, and the mineral oil is shown in FIG. 3. In FIG. 3, the unit of the blending ratio of raw materials is wt %. In Examples 1 and 2, the blending ratio of the pearl powder was set to about 5.5 wt %. The prepared creamy substances in Examples 1 and 2 were visually checked, and it was observed that both of the creamy substances had glossiness. It was also found that the dried and solidified creamy substances thus prepared had glossiness and were excellent in decorativeness.

### REFERENCE SIGNS LIST

10 creamy substance
20 piping tool
22 container
24 discharge port
30 pedestal
30a upper surface
32 decoration support portion
34 annular convex portion
40 decoration

1. A creamy substance for preparing a decoration toy, comprising:
a resin, and
a coloring agent consisting of a pearl powder,
wherein the creamy substance is discharged from a piping tool.

2. The creamy substance according to claim 1, wherein the creamy substance contains the coloring agent in a range of 5 wt % to 6 wt %.

3. The creamy substance according to claim 1, wherein the resin is a polyacrylic emulsion.

4. The creamy substance according to claim 3, wherein the polyacrylic emulsion comprises ethyl acrylate and butyl acrylate.

5. A piping tool for preparing a decoration toy comprising:
a container,
a discharge port, and
the creamy substance according to claim 1,
wherein the creamy substance is filled in the container.

6. A decoration toy, comprising:
a pedestal, and
the creamy substance according to claim 1,
wherein the pedestal comprises a decoration support portion and an annular convex portion,
wherein the annular convex portion is provided on an upper surface of an outer periphery of the decoration support portion.

7. The decoration toy according to claim 6, wherein the creamy substance is dried and solidified.

8. The decoration toy according to claim 6, wherein the pedestal is formed of a resin.

9. The decoration toy according to claim 6, wherein the decoration support portion protrudes in a substantially right circular conical shape.

10. The decoration toy according to claim 6, wherein the creamy substance is put on the decoration support portion.
